(19) United States
(12) Patent Application Publication
(10) Pub. No.: US 2025/0161157 A1
(43) Pub. Date: May 22, 2025

(54) Vibrator Structure of Shallow Acupuncture Instrument

(71) Applicant: Zhongshu (Fujian) Medical Technology, Inc., Fuzhou (CN)

(72) Inventors: Jianping He, Fuzhou (CN); Feng Wang, Fuzhou (CN)

(73) Assignee: Zhongshu (Fujian) Medical Technology, Inc., Fuzhou (CN)

(21) Appl. No.: 18/942,858

(22) Filed: Nov. 11, 2024

(30) Foreign Application Priority Data
Nov. 16, 2023 (CN) 2023231025813

(51) Int. Cl. A61H 39/00; A61H 39/08

(52) U.S. Cl. CPC A61H 39/007; A61H 39/086; A61H 2201/0176; A61H 2201/5071

(57) ABSTRACT

The invention discloses a vibrator structure of a shallow acupuncture instrument. The vibrator structure includes a vibrating head and a vibration generation component. The vibrating head is in contact with the vibration generation component. The bottom of the vibrating head is in contact with the vibration generation component, and its tip is contacting acupuncture recipient. The vibration generational component is electrically connected to a power amplifier circuit which amplifies electric signals corresponding to vibration parameters. The amplified electric signals, corresponding to the vibration parameters, drive the vibration generation component to vibrate. The generated vibration is then transmitted to the vibrating head, thereby reproducing the vibration waves of shallow-needle acupuncture techniques.

### CROSS-REFERENCE TO RELATED APPLICATION

This application claims priority of Chinese application No. 202323102581.3 filed on Nov. 16, 2023.

### TECHNICAL FIELD

The invention relates to the technical field of the shallow acupuncture instrument, in particular to a vibrator structure of the shallow acupuncture instrument.

### BACKGROUND

A current existing shallow acupuncture instrument includes a control box and a shallow-needle head at the bottom of the control box. Fixing straps are provided at both sides of the control box for fixing the control box to the human body. The control box is internally equipped with an MCU, three sets of eccentric wheel vibration motors, and a storage module. The storage module is used to store vibration parameters. The eccentric wheel vibration motors are connected to the shallow-needle head, vibrate according to the vibration parameters, and drive the shallow-needle head to vibrate.

The disadvantages of the above shallow acupuncture instrument are: eccentric wheel vibration motor is made with an eccentric wheel on the motor shaft of a DC motor; when the motor rotates, the center of mass of the eccentric wheel is not in the motor axis, making the motor itself in a constant imbalanced state, resulting in vibration. The rotational speed of the motor determines the base frequency of vibration. Therefore, the eccentric wheel vibration motor can only realize the general sense of vibration, and cannot accurately reproduce the vibration waves of the shallow-needle acupuncture techniques.

In view of the aforementioned insufficiency, it is necessary to design a new vibrator structure for the shallow acupuncture instrument.

### SUMMARY

Therefore, the technical issue to be solved by the invention is that, the current existing shallow acupuncture instrument, driving shallow-needle to vibrate by eccentric wheel vibration motor, is unable to accurately reproduce the vibration waves of shallow-needle acupuncture techniques. Accordingly, a new vibrator structure is provided herein.

In order to solve the above technical issue, the technical solution of the invention is as follows:

A vibrator structure of the shallow acupuncture instrument, includes a vibrating head and a vibration generation component; the bottom of the vibrating head is in contact with the vibration generation component; the vibration generation component is electrically connected to a power amplifier circuit on a circuit board inside the shallow acupuncture instrument; the power amplifier circuit amplifies electrical signals corresponding to vibration parameters; and the amplified electrical signal, corresponding to the vibration parameters, drives the vibration generation component to vibrate. The generated vibration is then transmitted to the vibrating head.

Further, the vibration generation component is a bone conduction vibrator or a flat plate vibrator.

Further, the vibrator structure further includes a limiting structure which forms a limiting cavity; the vibration generation component is arranged on the inner bottom wall of the limiting structure; the bottom of the vibrating head is arranged in the limiting cavity and the tip protrudes out of the limiting structure.

Further, the limiting structure includes a limiting base and a limiting element capped together; the vibration generation component is arranged on the inner wall of the inner bottom wall of the limiting base; and the limiting element presses the bottom of the vibrating heat in contact with the vibration generation component.

Further, the limiting element is a silicone sleeve.

Further, the vibrator structure further includes a pressure monitoring element which is in contact with the limiting base to monitor the pressure of the vibrating head when contacting acupuncture recipient; and preferably, the pressure monitoring element is in contact with the outer wall of the limiting base.

Further, the pressure monitoring element is a thin-film pressure sensor; a silicone sheet is provided between the thin-film pressure sensor and the limiting base; and/or, the pressure monitoring element is a pressure sensing chip.

Further, the vibrator structure further includes a fixing structure; the limiting structure partly enters into the fixing structure, with the other parts protruding out of the fixing structure; and the fixing structure is used to fix the limiting structure.

Further, the fixing structure includes the first fixing structure and the second fixing structure which are connected together by threads; the first fixing structure is provided with a pressing frame which presses the limiting structure towards the second fixing structure tightly.

Further, the inner bottom wall of the second fixing structure is provided with a limiting rib for limiting the pressure monitoring element.

The technical solution of the invention has the following advantages:

1. A vibrator structure of the shallow acupuncture instrument provided by the invention includes a vibrating head and a vibration generation component, and the vibrating head is in contact with the vibration generation component. The bottom of the vibrating head is in contact with the vibration generation component, and its tip is contacting acupuncture recipient. The vibration generation component is electrically connected to a power amplifier circuit on a circuit board inside the shallow acupuncture instrument; the power amplifier circuit amplifies electrical signals corresponding to vibration parameters; and the amplified electrical signals, corresponding to the vibration parameters, drive the vibration generation component to vibrate. The generated vibration is then transmitted to the vibrating head, thereby reproducing the vibration waves of shallow-needle acupuncture techniques.

2. The vibrator structure provided by the invention further includes a pressure monitoring element which is in contact with the limiting base to monitor the pressure of the vibrating head when contacting acupuncture recipient; and preferably, the pressure monitoring element is in contact with the outer wall of the limiting base. The shallow acupuncture instrument does not enter vibration working mode when the pressure value monitored by the pressure monitoring element is lower than the minimum pressure threshold value, and only when the pressure value monitored arrives at the minimum pressure threshold value, the shallow acupuncture instrument can enter vibration working mode, hence to ensure the effect of shallow acupuncture operation.

### BRIEF DESCRIPTION OF THE DRAWINGS

To provide a clearer illustration of specific embodiments of the invention or technical solutions in the prior art, a brief description of the drawings required to describe specific embodiments or the prior art will be given below. Apparently, the drawings described below are some of the embodiments of the invention, based on which other drawings can be acquired by those of ordinary skill in the art without any inventive efforts.

FIG. 1 is the schematic diagram of three-dimensional structure of the shallow acupuncture instrument with its first casing removed;

FIG. 2 is the schematic diagram of some components of the shallow acupuncture instrument according to one embodiment of the invention;

FIG. 3 is the schematic diagram of three-dimensional structure of the first fixing structure and the vibrating head of the shallow acupuncture instrument according to one embodiment of the invention;

FIG. 4 is the partial section view of the shallow acupuncture instrument according to one embodiment of the invention;

FIG. 5 is the schematic diagram of some internal structures of the shallow acupuncture instrument according to one embodiment of the invention;

FIG. 6 is the structural diagram of a shallow needling;

FIG. 7 is the schematic diagram of a vibration signal acquisition module and a data processing module according to one embodiment of the invention;

FIG. 8 is the schematic diagram of the bonding of the acceleration sensor and the shallow needle according to one embodiment of the invention;

FIG. 9 is a schematic diagram of the connection of shallow needle, pressure parameter acquisition module, and data processing module according to one embodiment of the invention.

### REFERENCE SIGNS ON DRAWINGS

1. vibration signal acquisition module; 11. acceleration sensor; 12. wire; 13. USB interface board; 2. Pressing-pressure signal acquisition module; 3. data processing module; 4. shallow needle; 41. helix coil; 5. shallow acupuncture instrument; 5a. casing; 5d. USB interface; 50. vibrating head; 500. bottom of vibrating head; 501. tip; 51. vibration generation component; 52. limiting element; 520. top; 521. bottom of limiting element; 53. limiting base; 54. fixing structure; 540. first fixing structure; 541. pressing frame; 542. second fixing structure; 5421. limiting ribs; 543. positioning pin; 56. thin-film pressure sensor; 57. silicone sheet; 58. lithium battery; 59. circuit board.

### DETAILED DESCRIPTION OF EMBODIMENTS

A clear and complete description of the technical solutions in the invention will be given below in combination with the drawings. Apparently, the embodiments described below are some, but not all, of the embodiments of the invention. All of the other embodiments, obtained by those of ordinary skill in the art on the basis of the embodiments of the invention without any creative efforts, fall into/within the protection scope of the invention.

In the description of the invention, it should be noted that the terms “center”, “top”, “bottom”, “left”, “right”, “vertical”, “horizontal”, “inside”, “outside” and the like indicate directional or positional relationships based on those shown in the drawings. These terms which are only intended to facilitate and simplify the description of the invention, do not indicate or imply that the device or element referred must have a particular orientation, or be constructed and operated in a particular orientation, and therefore shall not be construed as a limitation of the invention. Furthermore, the terms “first”, “second”, and “third” are used for descriptive purposes only and are not to be understood as indicating or implying relative importance.

In the description of the invention, it should be noted that, unless otherwise expressly provided and limited, the terms “mounted”, “bonded” and “connected” are to be broadly construed and may, for example, be construed as fixedly connected, detachably connected, integrally connected, or mechanically or electrically connected, directly connected or indirectly connected through intermediate media, or connected between two components. The specific meaning of the above terms in the invention can be understood according to specific situations by those of ordinary skill in the art.

Furthermore, the technical features involved in different embodiments of the invention described below can be combined as long as they do not conflict with each other.

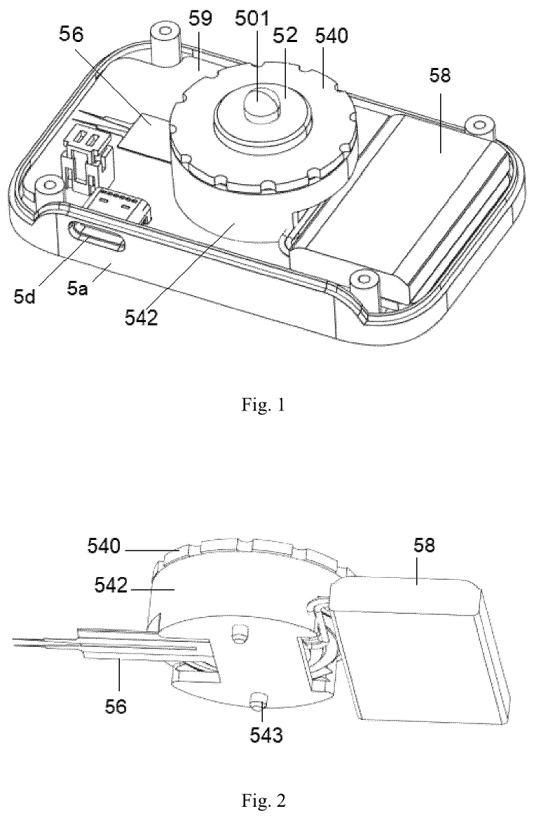

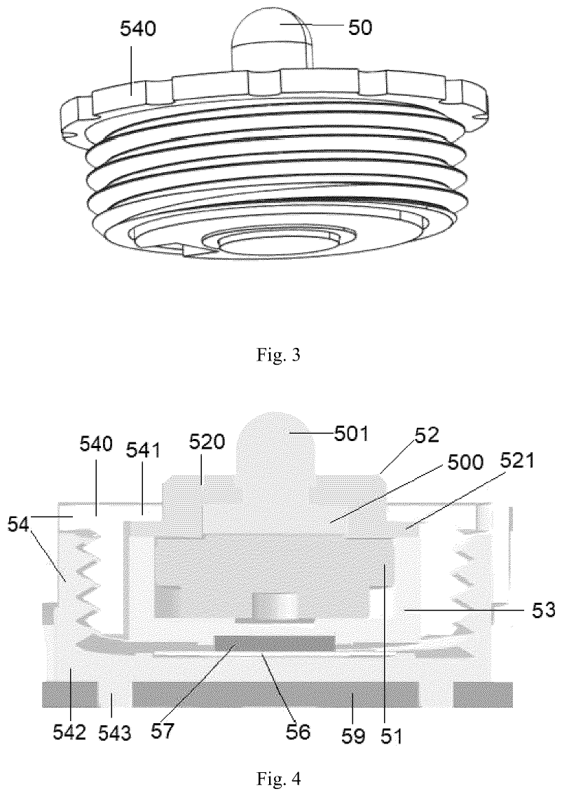

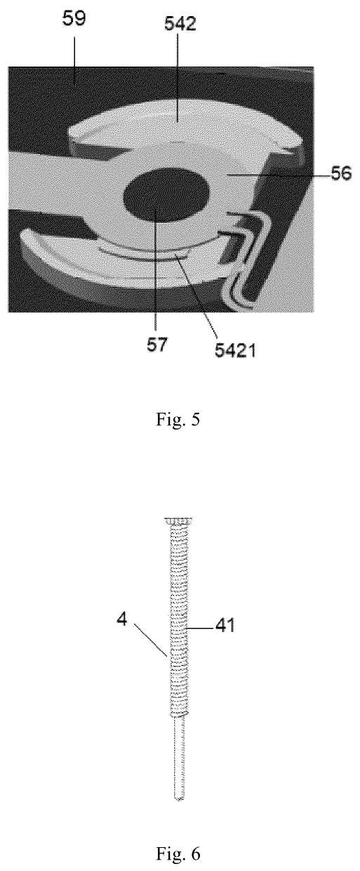

As shown in FIGS. 1 to 5, the shallow acupuncture instrument 5 provided in this embodiment includes a casing 5a, a vibrator structure, a lithium battery 58, and a circuit board 59.

The vibrator structure of the shallow acupuncture instrument includes a vibrating head 50, a vibration generation component 51, a limiting element 52, a limiting base 53, a fixing structure 54, and a pressure monitoring element.

The vibrating head 50 includes a bottom 500 and a tip 501. the bottom 500 has a dimension greater than that of the tip 501. The bottom 500 is arranged within the casing 5a and the tip 501 protrudes out of one side of the casing 5a. The vibrating head 50 is made of metallic materials. The casing 5a includes the first casing and the second casing, with the first casing being removed in FIG. 1. The casing 5 is provided with a USB interface 5d.

The limiting base 53 is a cavity in shape, the vibration generation component 51 is placed inside the limiting base 53, and the position of the vibration generation component 51 is limited by the limiting base 53. In this embodiment, the vibration generation component 51 is a bone-conduction vibrator which, of course, may be replaced with a flat vibrator.

The limiting element 52 is provided with a bottom 521 and a top 520. The top protrudes slightly out of the first casing of the casing 5a, but below the tip 501 of the vibrating head 50. The top 520 of the limiting element presses against the bottom 500 of the vibrating head 50 so that the vibrating head 50 can keep in good contact with the vibration generation component 51. The bottom 521 of the limiting element is placed on top of the limiting base 53. In this embodiment, the limiting element 52 is a silicone sleeve, and the tip 501 of the vibrating head 50 protrudes out of the first casing of the casing 5a through a hole in the silicone sleeve. The silicone sleeve protrudes outside the casing 5a, limits the vibrating head 50 from swinging significantly, and allows the vibrating head 50 to swing to a small extent relying on the elasticity of the sleeve.

The pressure monitoring element is in contact with the bottom of the limiting base 53. When the pressure monitoring element is a thin-film pressure monitoring element 56, a pressure conducting member is provided between the limiting base 53 and the pressure monitoring element 56. In this embodiment, the pressure conducting member is a silicone sheet 57. When the pressure monitoring element is a pressure sensing chip, the silicone sheet 57 may not be provided.

The fixing structure 54 includes the first fixing structure 540 and the second fixing structure 542 which are connected together by threads. An accommodation cavity is formed within the first fixing structure 540 and the second fixing structure 542. The limiting base 53 and the vibration generation component 51 are arranged within the accommodation cavity, and the pressure monitoring element 56 is placed on the inner bottom wall of the second fixing structure 542 and is limited by the limit ribs 5421 on the second fixing structure 542. In this embodiment, two limit ribs 5421 are symmetrically provided. The first fixing structure 540 is designed with a pressing frame 541, which presses the bottom 521 of the limiting element 52 towards the limiting base 53, ensuring the contact between the vibrating head 50 and the vibration generation component 51. A positioning pin 543 is provided on the second fixing structure 542, and inserts into a positioning hole on the circuit board 59.

The circuit board 59 includes a microcontroller, a storage module, and a power amplifier circuit. The vibration parameters and pressure parameters are stored in the storage module.

The aforementioned vibration parameters and pressure parameters are acquired by a multi-dimensional feature acquisition device for shallow-needle acupuncture techniques which includes a vibration signal acquisition module 1, a pressing-pressure signal acquisition module 2, and a data processing module 3.

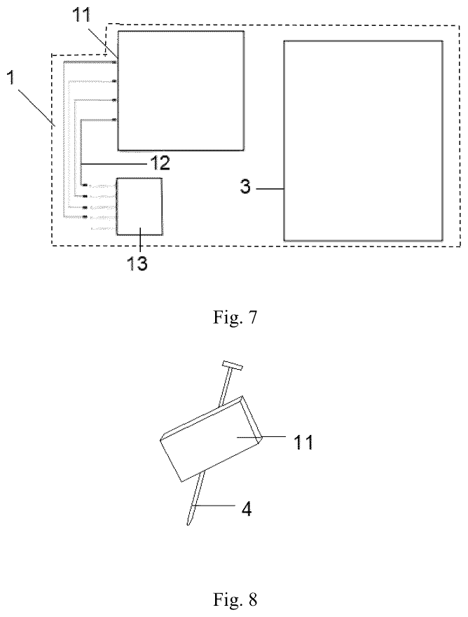

As shown in FIGS. 6 to 8, the vibration signal acquisition module 1 is used to acquire the vibration signals generated by scraping the helix coil 41 on the shallow needle 4 (the shallow needle 4 is manually operated acupuncture needle by itself alone, which is different from the shallow acupuncture instrument 5).

The data processing module 3 is electrically connected to the vibration signal acquisition module 1, to receive, analyze and process the vibration signals to obtain vibration parameters.

In this embodiment, the vibration signal acquisition module 1 includes acceleration sensor 11 and wire 12. The acceleration sensor 11 is bonded to one side of the shallow needle 4, and, the lengthwise direction of the shallow needle 4 is perpendicular to the plane on which the X-axis and the Y-axis of the acceleration sensor are located, so that the acceleration sensor 11 can monitor the vibration signal of the shallow needle 4 in the lengthwise direction in which the vibration sensation of the shallow needle 4 is the strongest. The acceleration sensor 11 is bonded to the shallow needle 4, so that the vibration conduction can be more direct. One end of the wire 12 is connected to the acceleration sensor 11, and the other end is connected to the data processing module 3 (in this embodiment, the data processing module 3 is a computer) via the USB interface board 13. The acceleration sensor 11 is a mature commercial product, and its structure will not be elaborated here.

During vibration signal acquisition, the helix coil 41 on the shallow needle 4 is scraped to cause the shallow needle 4 to vibrate. The acceleration sensor with supporting software kit is used to acquire the three-axe vibration acceleration values. A corresponding software program is written on PC computer to analyze and process the vibration signals of the shallow needle (specifically, the vibration signals are the three-axe acceleration values acquired by the acceleration sensor) to obtain vibration parameters, and the vibration parameters can be presented in the form of time-domain waveforms and spectrums in the computer. The vibration parameters are stored in a storage unit in a computer or, alternatively, transferred by wire to the storage module in the shallow acupuncture instrument 5. The generated vibration time-domain waveforms include the original vibration time-domain waveforms of shallow-needle acupuncture techniques and the synthesized vibration time-domain waveforms of simulating shallow-needle acupuncture techniques, so that the shallow acupuncture instrument 5 has two vibration modes. Of course, the vibration time-domain waveform may be either the original vibration time-domain waveforms of shallow-needle acupuncture techniques or the synthesized vibration time-domain waveforms of simulating shallow-needle acupuncture techniques. The original vibration time-domain waveform of acupuncture techniques is the PCM waveform sequence data that replicates the acupuncture techniques of acupuncturists.

The waveform of the reinforcing acupuncture method corresponds to the acupuncture technique of lightly upward scraping and heavily downward scraping, featuring the vibration waveform amplitude of the upward scraping in the first half is lower than that of the downward scraping in the second half;

The waveform of the reducing acupuncture method corresponds to the acupuncture technique of heavily upward scraping and lightly downward scraping, featuring the vibration waveform amplitude of upward scraping in the first half is greater than that of the downward scraping in the second half;

The waveform of the even reinforcing-reducing acupuncture method corresponds to the acupuncture technique of evenly upward and downward scraping, featuring the vibration waveform amplitude of upward scraping in the first half basically equals to that of downward scraping in the second half.

This enables the shallow acupuncture instrument 5 to have three modes of shallow acupuncture techniques (reinforcing, reducing and even reinforcing-reducing) to choose from.

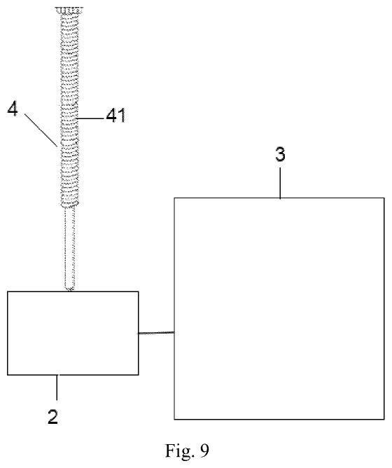

As shown in FIG. 9, the pressing-pressure signal acquisition module 2 is used to acquire pressure signals of pressing the shallow needle 4. The data processing module 3 is electrically connected to the pressing-pressure signal acquisition module 2 to receive, analyze and process the pressing-pressure signals, and obtains pressure parameters. Particularly, the pressing-pressure signal acquisition module 2 includes a push-pull force gauge and a wire. The push-pull force gauge is connected to the data processing module 3 via the wire, and the range of the push-pull force gauge is from 10 g to 200 g.

During signal acquisition, the acupuncturist presses the bottom of the shallow needle 4, so that the tip of the shallow needle 4 is vertically in contact with the push-pull force gauge which acquires pressure signals which are analyzed and processed by the data processing module 3 to obtain the numerical range of the pressure parameters. In this embodiment, the minimum value of the pressing pressure is 29 g and the maximum value is 126 g. Referring to the data acquired from four expert doctors in the rehabilitation department of Fujian Provincial Rehabilitation Hospital, who used three shallow-needle acupuncture techniques (reinforcing, reducing, and even reinforcing-reducing, respectively). A total of 12 groups of pressing-pressure data of the shallow needle 4 were acquired, and the pressing-pressure range is calculated as 53 g (in this embodiment, the minimum threshold value of the pressing pressure is 53 g) to 152 g (in this embodiment, the maximum threshold value of the pressing pressure is 152 g), in order to avoid that the pressing pressure is too small to affect the effect of shallow acupuncture operation. Of course, the minimum and maximum threshold values of the pressing pressure can also be selected and set according to actual needs.

The working process of the shallow acupuncture instrument 5 provided in the embodiment is described below:

The shallow acupuncture instrument 5 is tied to the acupuncture point of recipient with straps, and then turned on the power;

Appropriate vibration modes and acupuncture techniques are selected;

The pressure monitoring element monitors the pressure of the vibrating head 50 when contacting acupuncture recipient, and the pressure value is transmitted to the microcontroller on the circuit board 59, wherein the microcontroller compares the pressure value with the minimum threshold value and the maximum threshold value. If the pressure value is less than the minimum threshold value, the shallow acupuncture instrument 5 does not enter vibration working mode, because the effect of shallow acupuncture operation will be affected if the pressure is too small; and if the pressure value is between the minimum threshold value and the maximum threshold value, the shallow acupuncture instrument 5 enters vibration working mode to realize the corresponding vibration modes and the acupuncture modes. Particularly, the microcontroller reads the electrical signals of the vibration parameters from the storage module, decodes and outputs the signals to the amplifier circuit. The electrical signals of the waveform data of vibration modes are amplified by the power amplifier circuit and transmitted to the vibration generation component 51. The amplified electric signals drive the vibration generation component 51 to vibrate. The generated vibration is then transmitted to the vibrating head 50, thereby reproducing the vibration waves of shallow-needle acupuncture techniques. If the pressure value is greater than the maximum threshold value, the shallow acupuncture instrument 5 does not enter vibration working mode because such pressure will cause discomfort to the acupuncture recipient. Obviously, it is also possible to set only the minimum threshold value without setting the maximum threshold value; when the pressure is too high, the acupuncture recipient usually consciously relieves the discomfort by adjusting the tightness of the strap.

Obviously, the above embodiments are merely examples and do not limit the invention. Other modifications or variations in different forms may be made by those of ordinary skill in the art on the basis of the foregoing descriptions. It is neither necessary nor possible to elaborate all of the embodiments herein. Obvious modifications or variations derived herefrom are still within the scope of protection of the invention.

1. A vibrator structure of a shallow acupuncture instrument, wherein the vibrator structure includes a vibrating head and a vibration generation component; the bottom of the vibrating head is in contact with the vibration generation component, and a tip of the vibration generation component is contacting acupuncture recipient; the vibration generation component is electrically connected to a power amplifier circuit on a circuit board in the shallow acupuncture instrument; the power amplifier circuit amplifies electrical signals corresponding to vibration parameters; and the amplified electrical signals, corresponding to the vibration parameters, drive the vibration generation component to vibrate. The generated vibration is then transmitted to the vibrating head.

2. The vibrator structure of the shallow acupuncture instrument according to claim 1, wherein the vibration generation component is a bone conduction vibrator or a flat plate vibrator.

3. The vibrator structure of the shallow acupuncture instrument according to claim 1, wherein the vibrator structure further includes a limiting structure which forms a limiting cavity; the vibration generation component is arranged on the inner bottom wall of the limiting structure; the bottom of the vibrating head is arranged in the limiting cavity; and the tip protrudes out of the limiting structure.

4. The vibrator structure of the shallow acupuncture instrument according to claim 3, wherein the limiting structure includes a limiting base and a limiting element capped together; the vibration generation component is arranged on the inner wall of the limiting base; and the limiting element presses the bottom of the vibrating head in contact with the vibration generation component.

5. The vibrator structure of the shallow acupuncture instrument according to claim 4, wherein the limiting element is a silicone sleeve.

6. The vibrator structure of the shallow acupuncture instrument according to claim 3, wherein the vibrator structure further includes a pressure monitoring element which is in contact with the limiting base to monitor the pressure of the vibrating head when contacting the acupuncture recipient; and preferably, the pressure monitoring element is in contact with the outer wall of the limiting base.

7. The vibrator structure of the shallow acupuncture instrument according to claim 6, wherein the pressure monitoring element is a thin-film pressure sensor; a silicone sheet is provided between the thin-film pressure sensor and the limiting base; and/or, the pressure monitoring element is a pressure sensing chip.

8. The vibrator structure of the shallow acupuncture instrument according to claim 6, wherein the vibrator structure further includes a fixing structure; the limiting structure partly enters into the fixing structure, with the other parts protruding out of the fixing structure; and the fixing structure is used to fix the limiting structure.

9. The vibrator structure of the shallow acupuncture instrument according to claim 8, wherein the fixing structure includes the first fixing structure and the second fixing structure which are connected together by threads; the first fixing structure is provided with a pressing frame which presses the limiting structure towards the second fixing structure tightly.

10. The vibrator structure of the shallow acupuncture instrument according to claim 9, wherein the inner bottom wall of the second fixing structure is provided with a limiting rib for limiting the pressure monitoring element.
